(19) United States
(12) Patent Application Publication
(10) Pub. No.: US 2026/0008371 A1
(43) Pub. Date: Jan. 8, 2026

(54) METHOD FOR COORDINATING AN EXECUTION OF AN AUTOMATED CHARGING AND/OR DISCHARGING PROCESS OF A BATTERY OF A MOTOR VEHICLE

(71) Applicant: Robert Bosch GmbH, Stuttgart (DE)

(72) Inventors: Stefan Nordbruch, Leonberg (DE); Jan Leininger, Ludwigsburg (DE); Vera Schumacher, Gerlingen (DE)

(21) Appl. No.: 19/234,511

(22) Filed: Jun. 11, 2025

(30) Foreign Application Priority Data
Jul. 4, 2024 (DE) 10 2024 206 301.0

(51) Int. Cl. B60L 53/36; B60L 53/14; B60L 53/31; B60L 53/66

(52) U.S. Cl. CPC B60L 53/36; B60L 53/14; B60L 53/31; B60L 53/66

(57) ABSTRACT

A method for coordinating an execution of an automated charging and/or discharging process of a battery of an at least highly automated motor vehicle. The method includes: a main system receives a request for executing an automated charging and/or discharging process of a battery of an at least highly automated motor vehicle; the main system starts an AVP system in order to guide the motor vehicle in an at least highly automated manner by means of the AVP system to a charging location as part of an AVP process; when the main system receives a message from the AVP system that the AVP process has been terminated, the main system starts an AVC system in order to charge and/or discharge the battery of the motor vehicle parked at the charging location, in an automated manner, using the AVC system as part of an AVC process, according to the request.

### CROSS REFERENCE

The present application claims the benefit under 35 U.S.C. § 119 of German Patent Application No. DE 102024 206 301.0 filed on July 4, 2024, which is expressly incorporated herein by reference in its entirety.

### FIELD

The present invention relates to a method and a main system for coordinating an execution of an automated charging and/or discharging process of a battery of an at least highly automated motor vehicle, to a system and a method for executing an automated charging and/or discharging process of a battery of an at least highly automated motor vehicle, to a computer program and to a machine-readable storage medium.

### BACKGROUND INFORMATION

U.S. Patent Application Publication No. US 2022/055495 A1 describes a charging system for a vehicle.

Japan Patent Application No. JP 2020-072625 A describes a charging device.

China Utility Model Specification CN 208930235 U describes a charging robot.

China Utility Model Specification CN 218138153 U describes a charging system for a vehicle.

Germany Patent Application No. DE 102018003467 A1 describes a method for autonomous parking and electrical charging of an energy store of a motor vehicle.

China Patent Application No. CN 106183843 A describes a stationary electric vehicle charging station.

China Utility Model Specification CN 208930235 U describes automated parking of a vehicle as well as a charging station for automatically executing a charging process.

U.S. Patent Application Publication No. US 2022/0055495 A1 describes automated parking of a vehicle as well as a charging station for automatically executing a charging process.

PCT Patent Application No. WO 2022/040556 A1 describes a method for automatically charging an electrical energy store of a vehicle in a charging station with charging parking spots by means of an automated charging unit.

### SUMMARY

An object of the present invention is to provide a concept for coordinating an execution of an automated charging and/or discharging process of a battery of an at least highly automated motor vehicle so that the battery can be charged and/or discharged in an automated manner based on the coordination.

This object may be achieved by means of certain features of the present invention. Advantageous embodiments of the present invention are disclosed herein.

According to a first aspect of the present invention, a method for coordinating an execution of an automated charging and/or discharging process of a battery of an at least highly automated motor vehicle is provided. According to an example embodiment of the present invention, the method comprises the following steps: a main system receives a request for executing an automated charging and/or discharging process of a battery of an at least highly automated motor vehicle, the main system starts an AVP system in order to guide the motor vehicle in an at least highly automated manner by means of the AVP system to a charging location as part of an AVP process, when the main system receives a message from the AVP system that the AVP process has been terminated, the main system starts an AVC system in order to charge and/or discharge the battery of the motor vehicle parked at the charging location, in an automated manner, by means of the AVC system as part of an AVC process, according to the request.

According to a second aspect of the present invention, a main system for coordinating an execution of an automated charging and/or discharging process of a battery of an at least highly automated motor vehicle is provided, wherein the main system is configured to perform all the steps of the method according to the first aspect of the present invention.

According to a third aspect of the present invention, a system for executing an automated charging and/or discharging process of a battery of an at least highly automated motor vehicle is provided, comprising: the main system according to the second aspect of the present invention, an AVP system and an AVC system.

According to a fourth aspect of the present invention, a method for executing an automated charging and/or discharging process of a battery of an at least highly automated motor vehicle by using the system according to the third aspect is provided. According to an example embodiment of the present invention, the main system coordinates the execution of the automated charging and/or discharging process of the battery of the at least highly automated motor vehicle according to the method according to the first aspect of the present invention so that the motor vehicle is accordingly guided in an at least highly automated manner by the AVP system to the charging location as part of an AVP process and so that the battery of the motor vehicle parked at the charging location is charged and/or discharged in an automated manner by the AVC system as part of the AVC process, according to the request.

According to a fifth aspect of the present invention, a computer program is provided, comprising commands that, when the computer program is executed by a computer, cause the computer to perform a method according to the first aspect of the present invention and/or according to the fourth aspect of the present invention.

According to a sixth aspect, a machine-readable storage medium is provided, on which the computer program according to the fifth aspect is stored.

The present invention is based on and includes the finding that the above object is achieved in that an instance independent of the AVP system and of the AVC system, in the present case the main system, coordinates the execution of an automated charging and/or discharging process of a battery of an at least highly automated motor vehicle. This in particular results in the technical advantage that the execution can be efficiently coordinated. By providing the main system, the AVP system and the AVC system are thus relieved of coordinating the execution and therefore do not have to perform it themselves.

Furthermore, providing the main system, which starts the AVC system only when receiving a message from the AVP system that the AVP process has been terminated, results in the technical advantage that it can be efficiently ensured that the AVP process must have ended first before automated charging and/or discharging can be started.

Thus, the two processes, the AVP process and the AVC process, are decoupled from each other.

At any given time, it is thus clear what is responsible: either the AVP system or the AVC system or even the main system.

Furthermore, this results in the technical advantage, for example, that the AVP system and the AVC system can be implemented independently of each other. In particular, this results in the technical advantage that the AVP system and the AVC system can each be operated by different operators. In particular, this results in the technical advantage that access by the AVP system and by the AVC system can be efficiently controlled and/or regulated. The AVC system only being started when the AVP system has sent a corresponding message about the end of the AVP process to the main system thus results in the technical advantage, for example, that the AVC system can only access the motor vehicle for charging and discharging purposes when the AVP process has ended. As long as the AVP process is still being executed, the AVC system is not yet started and thus cannot access the motor vehicle.

In particular, this results in the technical advantage that a concept for efficiently coordinating an execution of an automated charging and/or discharging process of a battery of an at least highly automated motor vehicle is provided. Based on the coordination, the battery can thus be charged efficiently in an automated manner and/or charged efficiently.

Starting a system, in particular the AVP system and/or the AVC system, in particular comprises logging into the system, for example by means of a user interface (UI), for example by means of an app, in particular a smartphone app. After logging in, the corresponding process, in particular the AVP process and/or the AVC process, is then begun or started.

A motor vehicle within the meaning of the description is, for example, an electric motor vehicle or, for example, a hybrid motor vehicle.

A battery within the meaning of the description is, for example, a drive battery. A drive battery is a battery that is primarily intended to supply electrical energy to the electric motor that provides propulsion for the electric motor vehicle or hybrid motor vehicle. The drive battery can also be referred to as a high-voltage battery, a traction battery, or a deep cycle battery.

AVP stands for "Automated Valet Parking." AVC stands for "Automated Valet Charging." An AVP system can therefore in particular be a system that guides a suitably equipped motor vehicle as part of an AVP process in an at least highly automated manner, i.e., controls and/or coordinates an AVP process. An AVC system is in particular a system that coordinates its charging and/or discharging process for a battery of an at least highly automated motor vehicle.

According to one example embodiment of the method according to the first aspect of the present invention, it is provided that it comprises the following: when the main system receives a message from the AVC system that the AVC process has been terminated, the main system starts the AVP system in order to guide the motor vehicle in an at least highly automated manner, by means of the AVP system as part of an AVP process, to a further location different from the charging location, in particular to a parking position or pick-up position.

This results in the technical advantage, for example, that the motor vehicle can be efficiently guided by the AVP system to a further location after charging and/or discharging of the battery has ended. The further location is, for example, a parking position or is, for example, a pick-up position, where the motor vehicle can be picked up by a person.

According to this example embodiment, it is thus in particular provided that, after the AVC process has ended, the AVP system guides the motor vehicle in an at least highly automated manner from the charging location to the further location according to an AVP process and/or as part of an AVP process.

In one example embodiment of the method according to the first aspect of the present invention, it is provided that the main system sends a monitoring request to the AVP system that the AVP system is to monitor the charging and/or discharging of the battery by the AVC system.

This results in the technical advantage, for example, that the charging and/or discharging of the battery can be efficiently monitored.

For executing the AVP process, the AVP system comprises one or more environmental sensors that are arranged so as to be spatially distributed within an infrastructure through which the motor vehicle is guided and/or is to be guided by the AVP system in an at least highly automated manner according to an AVP process. The infrastructure includes, for example, a parking space, such as a parking facility or a parking garage.

These environmental sensors are thus used in particular to monitor the charging and/or discharging. According to this example embodiment of the present invention, it is thus provided that the responsibility for monitoring lies with the AVP system.

Furthermore, this in particular results in the technical advantage that the AVC system itself does not need to have its own environmental sensors for monitoring. This allows the AVC system to be implemented in a technically simpler and less complex manner.

The charging location is thus located, for example, within the infrastructure, i.e., for example, within the parking area, for example within the parking garage or within the parking facility.

Thus, in particular, an infrastructure is provided within which the motor vehicle is located for executing the AVP process and for executing the AVC process. As stated above, this infrastructure is, for example, a parking area, for example a parking garage or a parking facility.

An environmental sensor within the meaning of the description is, for example, one of the following environmental sensors: radar sensor, lidar sensor, ultrasonic sensor, image sensor, in particular image sensor of a video camera, magnetic field sensor, and infrared sensor.

Monitoring within the meaning of the description is thus performed in particular using one or more environmental sensors that are arranged so as to be spatially distributed within the infrastructure. Environmental sensors that monitor the charging and/or discharging can thus detect the charging location and output environmental data based on the detection, which data represent the correspondingly detected environment, i.e., in particular the charging location and in particular a surrounding area of the charging location. These environmental data may for example be analyzed, in particular by the AVP system, in order for example to detect a dangerous situation, i.e., a hazard, in order for example to be able to respond to it accordingly. This is explained below by way of example with reference to further embodiments.

In one example embodiment of the method according to the first aspect of the present invention, it is provided that the main system specifies a safety area which comprises a charging robot provided for charging and/or discharging and is to be monitored by the AVP system during charging and/or discharging, and that the main system informs the AVP system of said safety area.

This results in the technical advantage, for example, that safety for the motor vehicle and/or for an environment of the motor vehicle can be efficiently increased. According to this embodiment, it is thus provided that a safety area is specified or defined, which is monitored by the AVP system during charging and/or discharging. Monitoring can thus be performed efficiently. The safety area comprises the charging robot, which is provided for charging and/or discharging.

In one example embodiment of the method according to the first aspect of the present invention, it is provided that the main system receives from the AVC system a planned movement area of a charging robot provided for charging and/or discharging, wherein the main system specifies the safety area based on the planned movement area of the charging robot.

This results in the technical advantage, for example, that the safety area can be specified efficiently. In particular, it is specified, for example, that the safety area corresponds to the planned movement area.

Specifying such a safety area results in the technical advantage, for example, that the charging robot cannot cause any damage outside of its planned movement area, for example that no person is injured by the charging robot, and for example that no person can tamper with the charging robot. The charging robot itself therefore does not need to safeguard its own movements separately since this is achieved via the monitoring of the safety area.

For example, the safety area is adapted to the type of charging robot. The safety area may, for example, also change dynamically. This means that, for example, the safety area can be dynamically adapted by the main system to a speed mode and/or operation mode of the charging robot. The adaptation can alternatively or additionally be carried out by the AVC system, for example.

In one example embodiment of the method according to the first aspect of the present invention, it is provided that the main system informs the AVP system that, in the event of a hazard detected by the AVP system on the basis of the monitoring, the AVP system is to perform one or more safety actions.

This results in the technical advantage, for example, that it is possible to respond efficiently to a detected hazard.

In one example embodiment of the method according to the first aspect of the present invention, it is provided that the one or more safety actions are in each case an element selected from the following group of safety actions: switching off a charging robot provided for charging and/or discharging, interrupting an electrical connection between the battery and a charging station provided for charging and/or discharging, switching off a charging station provided for charging and/or discharging.

This results in the technical advantage, for example, that particularly suitable safety actions can be provided.

In one example embodiment of the method according to the first aspect of the present invention, it is provided that the main system informs the AVP system that a hazard is a breach of the safety area by a living being and/or by an object.

This results in the technical advantage, for example, that it is possible to respond efficiently to a breach of the safety area by a living being and/or an object.

A breach of the safety area means in particular that the living being and/or the object enters the safety area.

In one example embodiment of the method according to the first aspect of the present invention, it is provided that the main system informs the AVP system that it is to inform the AVC system when the motor vehicle has been parked at the charging location by the AVP system.

This results in the technical advantage, for example, that the AVC system can be efficiently informed that the AVP process has ended. Thus, it is in particular provided that the AVP system informs the AVC system when the motor vehicle has been parked at the charging location by the AVP system. The AVC system can thus prepare itself for the charging and/or discharging process, for example.

In one example embodiment of the method according to the first aspect of the present invention, it is provided that the main system informs the AVP system and/or the AVC system of the state in which the motor vehicle is to be when the corresponding process has ended, wherein the main system only starts one of the AVP system and the AVC system if the main system has received a message from the other of the AVP system and the AVC system that the motor vehicle is in the communicated state.

This results in the technical advantage, for example, that it can be efficiently ensured that the motor vehicle is in the communicated state before the main system starts the other of the AVP system and the AVC system. In particular, safety can thus be advantageously increased.

In one example embodiment of the method according to the first aspect of the present invention, it is provided that the state comprises that a drive motor of the motor vehicle is off and/or that a parking brake of the motor vehicle is activated and/or that a position of an automated or automatic transmission of the motor vehicle is in park, i.e., a park position with mechanical locking of the transmission against rolling away.

This results in the technical advantage, for example, that the state is a particularly safe state.

Statements made in connection with the method according to the first aspect of the present invention apply analogously to the main system according to the second aspect of the present invention, to the system according to the third aspect of the present invention, to the method according to the fourth aspect of the present invention, and vice versa.

This means in particular that technical functionalities and technical features of the method according to the first aspect of the present invention result analogously from corresponding technical functionalities and features of the main system according to the second aspect of the present invention, of the system according to the third aspect of the present invention, of the method according to the fourth aspect of the present invention, and vice versa.

The method according to the first aspect of the present invention is executed, for example, by means of the main system according to the second aspect of the present invention.

The method according to the fourth aspect of the present invention is executed, for example, by means of the system according to the third aspect of the present invention.

The system according to the third aspect of the present invention is configured, for example, to perform all steps of the method according to the fourth aspect of the present invention.

The method according to the first aspect of the present invention is, for example, a computer-implemented method.

The method according to the fourth aspect of the present invention is, for example, a computer-implemented method.

The main system according to the second aspect of the present invention is, for example, configured programmatically to execute the computer program.

The system according to the third aspect of the present invention is, for example, configured programmatically to execute the computer program.

The expression "computer according to the computer program according to the fifth aspect" in particular means the main system according to the second aspect and/or the system according to the third aspect.

The embodiments and exemplary embodiments described here can be combined with one another in any way, even if this is not explicitly described.

The present invention is explained in more detail below using preferred exemplary embodiments.

### BRIEF DESCRIPTION OF THE DRAWINGS

FIG. 1 shows a flow chart of an example method according to the first aspect of the present invention.

FIG. 2 shows an example main system according to the second aspect of the present invention.

FIG. 3 shows an example system according to the third aspect of the present invention.

FIG. 4 shows a flow chart of an example method according to the fourth aspect of the present invention.

FIG. 5 shows an example machine-readable storage medium according to the sixth aspect of the present invention.

FIG. 6 to 9 each show a block diagram according to example embodiments of the present invention.

In the following, the same reference signs can be used for identical features.

### DETAILED DESCRIPTION OF EXAMPLE EMBODIMENTS

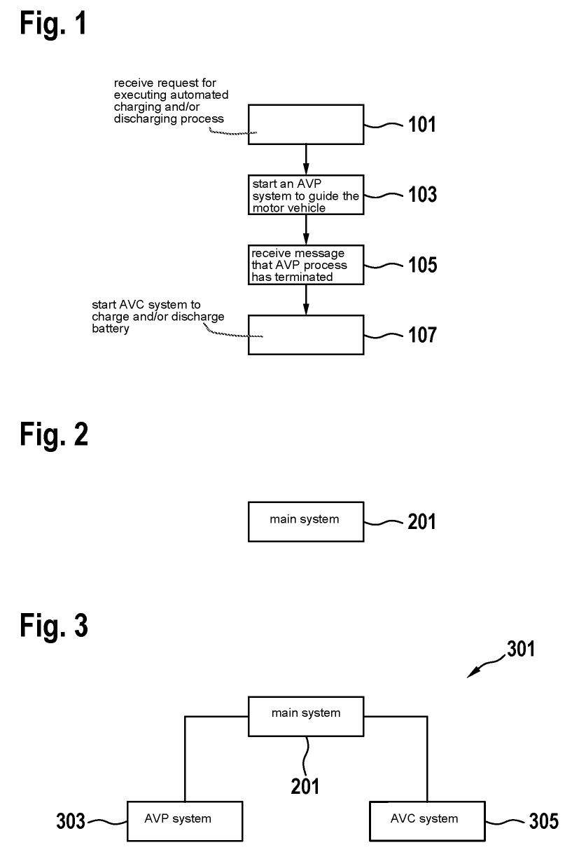

FIG. 1shows a flow chart of a method for coordinating an execution of an automated charging and/or discharging process of a battery of an at least highly automated motor vehicle, comprising the following steps: a main system receives 101 a request for executing an automated charging and/or discharging process of a battery of an at least highly automated motor vehicle, the main system starts 103 an AVP system in order to guide the motor vehicle in an at least highly automated manner by means of the AVP system to a charging location as part of an AVP process, when the main system receives 105 a message from the AVP system that the AVP process has been terminated, the main system starts 107 an AVC system in order to charge and/or discharge the battery of the motor vehicle parked at the charging location, in an automated manner, by means of the AVC system as part of an AVC process, according to the request.

FIG. 2 shows a main system 201 for coordinating an execution of an automated charging and/or discharging process of a battery of an at least highly automated motor vehicle, wherein the main system is configured to perform all the steps of the method according to the first aspect.

FIG. 3 shows a system 301 for executing an automated charging and/or discharging process of a battery of an at least highly automated motor vehicle, comprising: the main system 201 according to FIG. 2, an AVP system 303 and an AVC system 305.

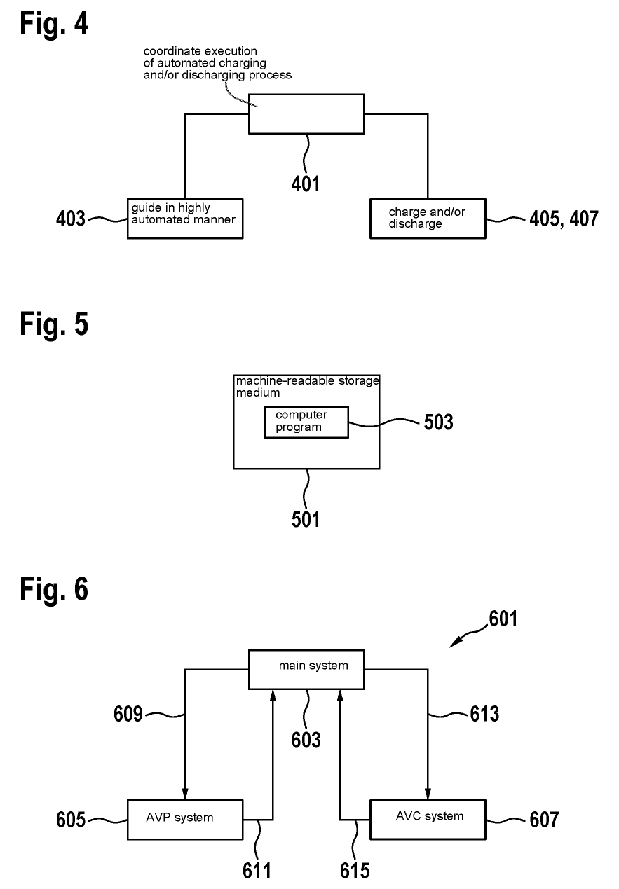

FIG. 4 shows a flow chart of a method for executing an automated charging and/or discharging process of a battery of an at least highly automated motor vehicle by using the system according to the third aspect, wherein the main system coordinates 401 the execution of the automated charging and/or discharging process of the battery of the at least highly automated motor vehicle according to the method according to the first aspect so that the motor vehicle is accordingly guided 403 in an at least highly automated manner by the AVP system to the charging location as part of an AVP process and so that the battery of the motor vehicle parked at the charging location is charged 405 and/or discharged 407 in an automated manner by the AVC system as part of the AVC process, according to the request.

FIG. 5 shows a machine-readable storage medium 501, on which a computer program 503 is stored. The computer program 503 comprises commands that, when the computer program 503 is executed by a computer, for example by the main system according to the second aspect and/or by the system according to the third aspect, cause the computer to perform a method according to the first aspect and/or according to the fourth aspect.

FIG. 6 shows a block diagram 601 which illustrates the concept described here by way of example. According to the concept described here, a main system 603, an AVP system 605 and an AVC system 607 are provided.

The basic idea of this concept is in particular that the processes, i.e., the AVP process and the AVC process, are decoupled so that there is clear responsibility for each phase (AVP or AVC). The main system 603, the AVP system 605 and the AVC system 607 are each implemented separately.

The main system 603 coordinates the execution of an automated charging and/or discharging process of a battery of an at least highly automated motor vehicle. Depending on whether the motor vehicle is to be guided according to an AVP process or whether the battery of the motor vehicle is to be charged and/or discharged according to an AVC process, the main system 603 starts either the AVP system 605 or the AVC system 607. Thus, responsibility is transferred from the main system 603 to the AVP system 605 or to the AVC system 607.

This means that the AVP process is under the responsibility of the AVP system 605. This means that the AVP process is under the responsibility of the AVC system 607.

The main system 603 may, for example, manage and/or perform booking, planning, billing, etc.

This means in particular that the main system 603 starts the AVP system 605 and thus also transfers responsibility for the AVP process to the AVP system 605. This transfer of responsibility is symbolically indicated by an arrow with reference sign 609.

The AVP system 605 drives the motor vehicle in an at least highly automated manner to a charging location as part of an AVP process. After the AVP process is complete or has ended, the AVP system 605 transfers responsibility back to the main system 603. This means that the AVP system 605 sends a message to the main system 603 that the AVP process has been terminated. This transfer of responsibility is symbolically indicated by an arrow with reference sign 611.

Only when this message is received by the main system 603 does the main system 603 start the AVC system 607 in order to charge and/or discharge the battery of the motor vehicle parked at the charging location, in an automated manner, by means of the AVC system 607 as part of an AVP process, according to the request. In other words, the responsibility for the AVC process is transferred from the main system 603 to the AVC system 607. This transfer of responsibility is symbolically indicated by an arrow with reference sign 613.

In response to the starting as part of an AVC process, the AVC system 607 will thus charge and/or discharge the battery of the motor vehicle parked at the charging location, in an automated manner, according to the request. For example, the use of a charging robot may be provided.

After the AVC process is complete or has ended, the AVC system 607 transfers responsibility for the motor vehicle back to the main system 603. This transfer of responsibility is symbolically indicated by an arrow with reference sign 615.

This means in particular that the AVC system 607 sends a message to the main system 603 that the AVC process has been terminated.

Optionally, it may be provided, for example, that, after the AVP process has ended, the motor vehicle is to be guided by the AVP system 605 to a further location according to an AVP process. This further location is different from the charging location and is, for example, a parking position or a pick-up position.

If this is the case, the main system 603 starts the AVP system 605, i.e., transfers responsibility for the AVP process to the AVP system 605. The latter then guides the motor vehicle to the further location according to an AVP process.

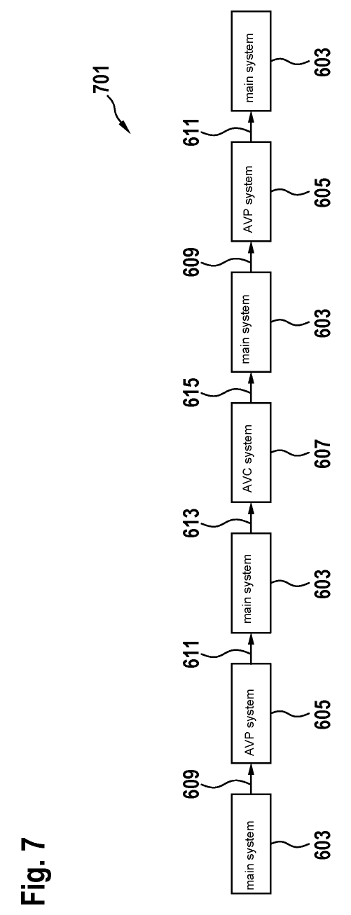

FIG. 7 shows a block diagram 701, which, by way of example, illustrates the above statements. From left to right with respect to the plane of the paper, the individual systems are drawn in the order of their execution in an exemplary embodiment.

The main system 603 transfers responsibility for the AVP process to the AVP system 605. After the AVP process has ended, responsibility is returned from the AVP system 605 to the main system 603. The latter transfers responsibility for the AVC process to the AVC system 607. After the AVC process has ended, the AVC system 607 returns responsibility to the main system 603.

As stated above, it may be provided, for example, that, after the AVC process has ended, the motor vehicle is driven by the AVP system 605 to a further location according to an AVP process.

Accordingly, the last two blocks are provided to illustrate this graphically. The main system 603 thus transfers responsibility for the AVP process to the AVP system 605, which then guides the motor vehicle to the further location according to an AVP process. After the motor vehicle has arrived at the further location, the AVP system 605 transfers the responsibility back to the main system 603. This last step can be omitted if, for example, the further location is a parking position where the motor vehicle is to be parked and is to stay parked. This step can be omitted, for example, if the further location is a pick-up position where a person picks up the motor vehicle for further use, so that the responsibility then passes to the person.

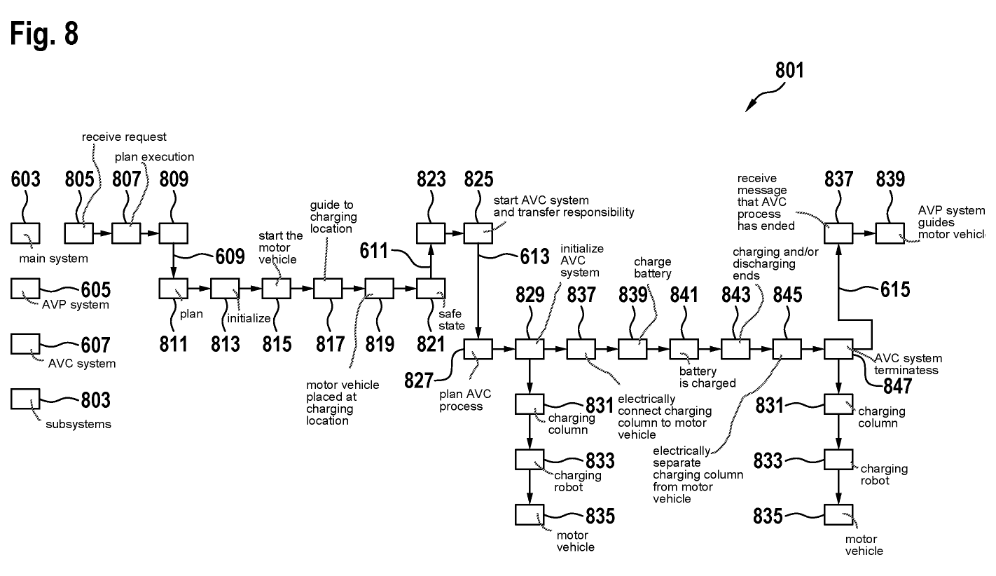

FIG. 8 shows a further block diagram 801 which illustrates the concept described here by way of example. With regard to the reference signs used in FIG. 8, reference is made to the above statements according to FIG. 6 and 7. The same reference signs are used.

In addition, reference sign 803 denotes subsystems that can be used as part of the concept described here, which is further described below. These subsystems 803 may, for example, be subsystems of the AVC system 607.

The method starts according to a block 805 at the main system 603, which receives, for example, a request for executing an automated charging and/or discharging process of a battery of an at least highly automated motor vehicle. The execution of planning for the automated charging and/or discharging process is performed according to a block 807 in order to create a plan for executing the automated charging and/or discharging process. The plan created according to function block 807 for executing the automated charging and/or discharging process is denoted in FIG. 8 by reference sign 811 and is transferred by the main system 603 to the AVP system 605. The latter starts and initializes itself according to a block 813 and executes an AVP process with the motor vehicle based on the planning, i.e., based on the plan 811. This comprises, for example, the AVP system 605 starting the motor vehicle according to a block 815. As part of the AVP process, the motor vehicle is guided in an at least highly automated manner by the AVP system 605 to the charging location according to a block 817. According to a block 819, it is provided that the AVP system places the motor vehicle at the charging location, in particular parks it there, as part of the AVP process. According to a block 821, it is provided that the AVP system 605 brings the motor vehicle into a safe state. In the safe state, for example, the drive motor is off and/or, for example, a handbrake of the motor vehicle is activated and/or, for example, a position of an automated or automatic transmission of the motor vehicle is in park.

After block 821, i.e., after the motor vehicle has been brought into the safe state by the AVP system 605, the AVP process has ended, which the AVP system 605 communicates to the main system 603 so that the responsibility is transferred back to the main system 603.

The main system 603 then starts the AVC system 607 according to a block 825 and transfers the corresponding responsibility for the AVC process to the AVC system 607. The latter independently plans the AVC process according to a block 827. According to a block 829, the AVC system 607 initializes and starts components and/or subsystems necessary to execute the AVC process. Such subsystems include, for example, a charging column 831, a charging robot 833 and the motor vehicle 835. This means that the AVC system 607 prepares the motor vehicle 835 to such an extent that the battery can be charged and/or discharged. This does not necessarily mean that the drive motor is switched on. This means that, for charging and/or discharging, the motor vehicle 835 does not necessarily have to be ready to drive. For example, it is only put into operation by the AVC system 607 to such an extent that the battery can be charged and/or discharged.

After starting and initialization according to block 829, it is provided according to a block 837 that the charging robot 833 is used to electrically connect the charging column 831 to the motor vehicle 835. According to a block 839, it is then provided that, for example, the battery is charged. For example, discharging may also be provided.

According to a block 841, the battery of the motor vehicle is thus charged and/or discharged.

In block 843, charging and/or discharging of the battery ends. In block 845, it is provided that the charging column 831 is electrically separated from the motor vehicle 835 and/or from the battery. This is done, for example, using the charging robot 833. The above steps with regard to blocks 837 to 845 are in particular part of an AVC process executed by the AVC system 607. In block 847, which is also comprised by the AVC process, the AVC system terminates the individual subsystems, which means that they are switched off. The charging column 849 is thus switched off. The charging robot 851 is thus switched off. The motor vehicle 853 is thus switched off. For example, the motor vehicle 835 is brought into a safe state.

After block 847 has ended, the AVP process has ended, which the AVC system 607 communicates to the main system 603. Accordingly, responsibility for the motor vehicle 835 is transferred from the AVC system 607 to the main system 603. According to a block 837, the main system 603 thus receives a message from the AVC system 607 that the AVC process has ended. Optionally, block 839 may be provided, which, according to the above statements, the motor vehicle 835 may be guided in an at least highly automated manner by the AVP system 605 to a further location as part of an AVP process. Here, for example, it is again provided that, according to the above statements, responsibility for the AVP process is transferred from the main system 603 to the AVP system 605. The above steps according to blocks 811 to 821 can thus be executed analogously in order to drive the motor vehicle by means of the AVP system 605 to the further location as part of the AVP process.

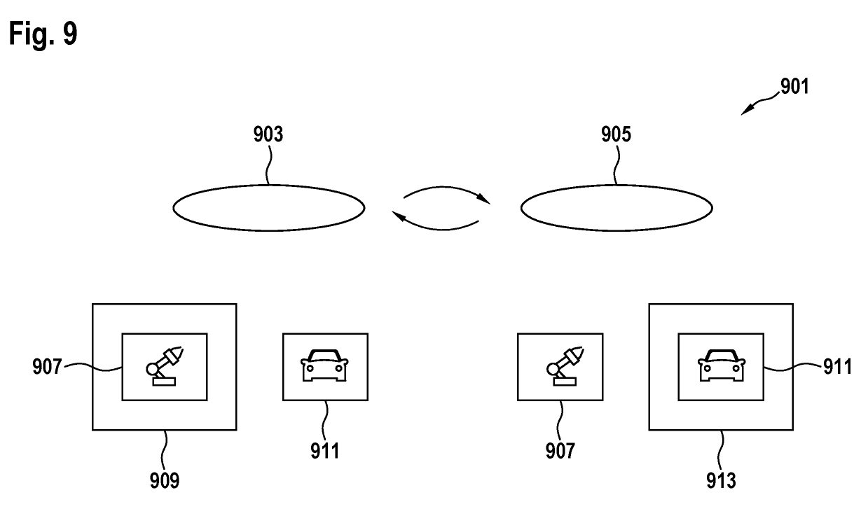

FIG. 9 shows a further block diagram 901, which illustrates the concept described here by way of example. According to the block diagram 901, an AVC process 903 is provided and an AVP process 905 is provided, which are executed by the AVC system and by the AVP system, respectively, according to the above statements.

It is possible to switch between these two processes, wherein each switch is coordinated by the main system. This means that responsibility for the motor vehicle is always transferred via the main system and not directly between the two systems, i.e., between the AVP system and the AVC system.

For executing the AVC process, a charging robot 907 is provided around which a safety area 909 is specified, which is specified, for example, based on the planned movement area of the charging robot 907. The motor vehicle is denoted by reference sign 911 and can be charged by the charging robot 907 as part of the AVC process 903. It is provided, for example, that the AVP system monitors the safety area 909 for breaches.

In particular, the motor vehicle 911 is in a safe condition.

During the AVP process, it is provided, for example, that the charging robot 907 is switched off so that it can no longer pose a threat to a surrounding area. For example, around the motor vehicle 911, a further safety area 913 can be specified which is monitored by the AVP system for breaches by an object and/or by a living being, for example a human.

For example, it is provided that, after an AVP process or AVC process has ended, the motor vehicle is brought into a safe state; for example, the drive motor is switched off. Thus, it is in particular provided that the motor vehicle must be restarted for a further process.

This means, for example, that the AVP process begins with starting the motor vehicle and ends with parking and switching off the motor vehicle.

This means, for example, that the AVC process begins with the switched-off motor vehicle and the starting necessary for the charging process. In particular, starting as part of an AVC process does not necessarily mean that the motor vehicle is ready to drive, but rather that the AVC system puts it into operation from the switched-off state in such a way that the battery can be charged and/or discharged. At the end of the AVC process, the motor vehicle is switched off again so that it can then be restarted by the AVP system if necessary.

According to the concept described here, there is a clear separation of responsibility and, in particular, of access to the motor vehicle by the AVP system and by the AVC system, wherein the respective accesses are separate from one another. This means in particular that access to the motor vehicle always occurs either by the AVP system or by the AVC system but never simultaneously in one phase, i.e., during an AVP process or an AVC process. This means that only the AVP system has access to the motor vehicle as part of the AVP process, and the AVC system and in particular the main system do not. This means in particular that only the AVC system has access to the motor vehicle as part of the AVC process, and the AVP system and in particular the main system do not.

The concept described here thus comprises, in particular, that the motor vehicle is driven by the AVP system to the charging location where it is to be charged and/or discharged. Here, in particular, it is put into a safe state, i.e., for example brought to a standstill, and it is secured against rolling away, for example. The information that the motor vehicle is at the correct location, i.e., at the charging location, is reported to the main system, for example, which in turn reports it to the AVC system. The charging robot is activated by the AVC system, for example, and the motor vehicle is no longer given permission to move, for example. This means that the motor vehicle is switched from driving mode to charging and/or discharging mode.

During the AVC process, for example, the environmental sensors of the AVP system monitor an area around the charging robot. This area includes, for example, the entire planned movement area of the robot. If the charging robot moves too close to the edge of this area, the robot is switched off immediately, for example. If, for example, something from outside, such as a person, moves into the area, the robot is switched off immediately, for example. The term "robot" here refers to the charging robot.

This advantageously ensures that the charging robot cannot cause any damage outside of its planned movement area, so that, for example, no person is injured by the robot and so that, for example, no person can tamper with the robot or the motor vehicle. The charging robot itself does not need to safeguard its movements separately since this is done via the safety area. The size of the safety area is adapted, for example, to the type of charging robot. For example, the size of the safety area can also be dynamically adapted to the speed mode and/or operation mode of the charging robot.

For example, the safety area can be safeguarded by light barriers. This means that the charging robot can be switched off immediately if the light barrier is interrupted from either side. In particular, it is provided that the motor vehicle and the charging robot are both completely within the safety area. In such a case, it may be provided, for example, that this can be implemented independently of the monitoring by the AVP system.

What is claimed is:

1. A method for coordinating an execution of an automated charging and/or discharging process of a battery of an at least highly automated motor vehicle, comprising the following steps:
receiving, by a main system, a request for executing an automated charging and/or discharging process of a battery of the at least highly automated motor vehicle;
starting, by the main system, an automated valet parking (AVP) system to guide the motor vehicle in an at least highly automated manner via the AVP system to a charging location as part of an AVP process;
starting, by the main system, when the main system receives a message from the AVP system that the AVP process has been terminated, an automated valet charging (AVC) system to charge and/or discharge the battery of the motor vehicle parked at the charging location, in an automated manner, via the AVC system as part of an AVC process, according to the request.

2. The method according to claim 1, further comprising:
starting, by the main system, when the main system receives a message from the AVC system that the AVC process has been terminated, the AVP system to guide the motor vehicle in an at least highly automated manner, via the AVP system as part of an AVP process, to a further location different from the charging location, the further location being a parking position or pick-up position.

3. The method according to claim 1, wherein the main system sends a monitoring request to the AVP system that the AVP system is to monitor the charging and/or discharging of the battery by the AVC system.

4. The method according to claim 3, wherein the main system specifies a safety area which includes a charging robot provided for charging and/or discharging and is to be monitored by the AVP system during charging and/or discharging, and the main system informs the AVP system of the safety area.

5. The method according to claim 4, wherein the main system receives from the AVC system a planned movement area of the charging robot provided for charging and/or discharging, wherein the safety area is specified by the main system based on the planned movement area of the charging robot.

6. The method according to claim 3, wherein the main system informs the AVP system that, in the event of a hazard detected by the AVP system based on the monitoring, the AVP system is to perform one or more safety actions.

7. The method according to claim 6, wherein the one or more safety actions are in each case an element selected from the following group of safety actions: (i) switching off the charging robot provided for charging and/or discharging, (ii) interrupting an electrical connection between the battery and a charging station provided for charging and/or discharging, (iii) switching off the charging station provided for charging and/or discharging.

8. The method according to claim 6, wherein the main system specifies a safety area which includes a charging robot provided for charging and/or discharging and is to be monitored by the AVP system during charging and/or discharging, and the main system informs the AVP system of the safety area, and
wherein the main system informs the AVP system that a hazard is a breach of the safety area by a living being and/or by an object.

9. The method according to claim 1, wherein the main system informs the AVP system that it is to inform the AVC system when the motor vehicle has been parked at the charging location by the AVP system.

10. The method according to claim 1, wherein the main system informs the AVP system and/or the AVC system of a state in which the motor vehicle is to be when the AVP or AVC process has ended, wherein the main system starts one of the AVP system and the AVC system only when the main system has received a message from the other of the AVP system and the AVC system that the motor vehicle is in the state.

11. The method according to claim 10, wherein the state includes that a drive motor of the motor vehicle is off and/or that a parking brake of the motor vehicle is activated and/or that a position of an automated or automatic transmission of the motor vehicle is in a park position with mechanical locking of the transmission against rolling away.

12. A main system for coordinating an execution of an automated charging and/or discharging process of a battery of an at least highly automated motor vehicle, wherein the main system is configured to:
receive a request for executing an automated charging and/or discharging process of a battery of the at least highly automated motor vehicle;
start an automated valet parking (AVP) system to guide the motor vehicle in an at least highly automated manner via the AVP system to a charging location as part of an AVP process;
start, when the main system receives a message from the AVP system that the AVP process has been terminated, an automated valet charging (AVC) system to charge and/or discharge the battery of the motor vehicle parked at the charging location, in an automated manner, via the AVC system as part of an AVC process, according to the request.

13. A system for executing an automated charging and/or discharging process of a battery of an at least highly automated motor vehicle, comprising:
a main system;
an automated valet parking (AVP) system; and
an automated valet charging (AVC) system;
wherein the main system is configured to:
receive a request for executing an automated charging and/or discharging process of a battery of the at least highly automated motor vehicle;
start the AVP system to guide the motor vehicle in an at least highly automated manner via the AVP system to a charging location as part of an AVP process;
start, when the main system receives a message from the AVP system that the AVP process has been terminated, the AVC system to charge and/or discharge the battery of the motor vehicle parked at the charging location, in an automated manner, via the AVC system as part of an AVC process, according to the request.

14. A non-transitory machine-readable storage medium on which is stored a computer program including commands for coordinating an execution of an automated charging and/or discharging process of a battery of an at least highly automated motor vehicle, the commands, when executed by a computer, causing the computer to perform the following steps:
receiving, by a main system, a request for executing an automated charging and/or discharging process of a battery of the at least highly automated motor vehicle;
starting, by the main system, an automated valet parking (AVP) system to guide the motor vehicle in an at least highly automated manner via the AVP system to a charging location as part of an AVP process;
starting, by the main system, when the main system receives a message from the AVP system that the AVP process has been terminated, an automated valet charging (AVC) system to charge and/or discharge the battery of the motor vehicle parked at the charging location, in an automated manner, via the AVC system as part of an AVC process, according to the request.
